(19) United States
(12) Patent Application Publication
(10) Pub. No.: US 2025/0115171 A1
(43) Pub. Date: Apr. 10, 2025

(54) DEVICE FOR ADJUSTING POSITION OF VEHICLE SEAT

(71) Applicants: Hyundai Motor Company, Seoul (KR); Kia Corporation, Seoul (KR); Faurecia Korea, Ltd., Gyeonggi-do (KR); Hyundai Transys Inc., Chungcheongnam-do (KR)

(72) Inventors: Sang Soo Lee, Gyeonggi-do (KR); Ho Suk Jung, Gyeonggi-do (KR); Deok Soo Lim, Gyeonggi-do (KR); Sang Do Park, Seoul (KR); Chan Ho Jung, Gyeonggi-do (KR); Mu Young Kim, Gyeonggi-do (KR); Jin Sik Kim, Gyeonggi-do (KR); Youn Myung Joo, Gyeonggi-do (KR); Dong Gyu Shin, Gyeonggi-do (KR); Taek Jun Nam, Gyeonggi-do (KR); Gun Chu Park, Gyeonggi-do (KR)

(21) Appl. No.: 18/410,000

(22) Filed: Jan. 11, 2024

(30) Foreign Application Priority Data
Oct. 6, 2023 (KR) 10-2023-0133367

(51) Int. Cl. B60N 2/20; B60N 2/02

(52) U.S. Cl. CPC B60N 2/20; B60N 2/02253

(57) ABSTRACT

A device for adjusting a position of a vehicle seat has a structure in which two or more adjustment devices, such as lead screws for adjusting tilting, are connected to the opposite side portions of a seat cushion frame to allow the lead screws to rotate by two gearboxes connected to one motor, so that a seat cushion is stably tilted by the two or more lead screws and the opposite side portions of the seat cushion frame is stably supported by the two or more lead screws, in order to prevent shaking, vibration, and torsional deformation caused by a gap generated when tilting the seat cushion frame.

### CROSS-REFERENCE TO RELATED APPLICATION

This application claims under 35 U.S.C. § 119(a) the benefit of Korean Patent Application No. 10-2023-0133367, filed on Oct. 6, 2023, the entire contents of which are incorporated herein by reference.

### BACKGROUND

### (a) Technical Field

The present disclosure relates to a device for adjusting a position of a vehicle seat, more particularly, to the device that is configured to stably tilt a seat cushion to achieve a comfortable relaxation posture of the vehicle seat.

### (b) Description of the Related Art

A vehicle seat typically includes a seat cushion on which an occupant's lower body is seated, a seatback to support the occupant's upper body, and a headrest to support the occupant's neck and head. In addition, various seat position adjustment devices and convenience devices may be installed inside and outside the vehicle seat.

Moreover, for passengers to rest and sleep during long-distance traveling of a self-driving vehicle, and for a driver to rest when charging an electric vehicle, there is a demand for a seat mechanism capable of achieving a comfortable relaxation posture.

For reference, the comfortable relaxation posture is a posture in which the occupant's body pressure is evenly distributed as much as possible while seated on the vehicle seat, so that the occupant feels comfortable and at ease, e.g., as if in a state of weightlessness.

For example, the comfortable relaxation posture may be, as illustrated in FIG. 1 (RELATED ART), achieved by a tilting operation of the seat cushion and a reclining operation of the seatback to set the angle between the occupant's lower body supported by the seat cushion and the occupant's upper body supported by the seatback to approximately 105° to 120°.

A seat cushion tilting device of the prior art may tilt the seat cushion by a predetermined angle to achieve the comfortable relaxation posture but has a poor restraining force on a seat cushion frame within the seat cushion, generating a gap at the connected portion between the seat cushion tilting device and the seat cushion frame and thus causing shaking, vibration, and torsional deformation.

In other words, because the conventional motor and lead screw for tilting the seat cushion is connected only to one side portion of the seat cushion frame, the seat cushion frame may be deformed to one side due to vehicle vibration and occupant's loads acting on the seat cushion frame, generating a gap at the seat cushion frame and causing shake or vibration of the seat cushion frame.

The above information disclosed in this Background section is only for enhancement of understanding of the background of the present disclosure, and therefore it may contain information that does not form the prior art that is already known to a person of ordinary skill in the art.

### SUMMARY

The present disclosure provides a device for adjusting a position of a vehicle seat, the device having a structure in which two or more lead screws for tilting are connected to opposite side portions of a seat cushion frame to allow the lead screws to rotate by two gearboxes connected to one motor, so that a seat cushion may be stably tilted by the two or more lead screws and the opposite side portions of the seat cushion frame may be stably supported by each of the lead screws, thereby preventing shaking, vibration, and torsional deformation caused by a gap generated when tilting the seat cushion frame.

Another object of the present disclosure is to provide a device for adjusting the position of a vehicle seat, the device having a structure in which a height adjustment device is mounted at the rear portion of a seat cushion frame, allowing a raising and lowering operation of a seat cushion to be performed to adjust the height of the seat cushion in addition to a tilting operation of the seat cushion.

In one aspect, the present disclosure provides a device for adjusting the position of a vehicle seat, the device including a first side frame and a second side frame mounted to a pair of seat rails, respectively, a seat cushion frame operably connected to the first and second side frames, a support plate configured to connect the first side frame and the second side frame to each other, a first gearbox hinged to one end portion of the support plate, a second gearbox hinged to another end portion of the support plate, a first adjustment device having an upper end portion hinged to one front end portion of the seat cushion frame and having a lower end portion forwardly and rearwardly movably inserted and fastened to the first gearbox, a second adjustment device having an upper end portion hinged to another front end portion of the seat cushion frame and having a lower end portion forwardly and rearwardly movably inserted and fastened to the second gearbox, a base frame configured to connect the first gearbox and the second gearbox to each other, and a double-axis motor for tilt control mounted to the base frame and connected to the first gearbox and to the second gearbox so as to transmit thereto rotational power.

In a preferred embodiment, the seat cushion frame has opposite rear end portions hinged to rear end portions of the first and second side frames, respectively.

In a preferred embodiment, at one side position of an upper surface of the support plate, a first support bracket to which the first gearbox is hinged may be mounted.

In another preferred embodiment, at another side position of the upper surface of the support plate, a second support bracket to which the second gearbox is hinged may be mounted.

In another preferred embodiment, the first adjustment device is a first lead screw, and the second adjustment device is a second lead screw.

In still another preferred embodiment, the one front end portion of the seat cushion frame may have mounted thereto a first hinge bracket to which the upper end portion of the first lead screw is hinged.

In yet another preferred embodiment, the other front end portion of the seat cushion frame may have mounted thereto a second hinge bracket to which the upper end portion of the second lead screw is hinged.

In still yet another preferred embodiment, a first rotation transmission shaft configured to connect one output portion of the motor to an input portion of the first gearbox and a second rotation transmission shaft configured to connect another output portion of the motor to an input portion of the second gearbox may be adopted as a flexible cable.

In a further preferred embodiment, the opposite front end portions of the seat cushion frame may be connected to each other via a connection pipe and the opposite rear end portions of the seat cushion frame may be connected to each other via a connection pipe.

In another further preferred embodiment, the device may further include a height adjustment device mounted to the opposite rear end portions of the seat cushion frame and to the rear end portions of the first and second side frames, and configured to raise or lower the seat cushion frame.

In still another further preferred embodiment, the height adjustment device may include a first height adjustment link having an upper end portion hinged to one rear end portion of the seat cushion frame and having a lower end portion hinged to a rear end portion of the first side frame, a second height adjustment link having an upper end portion hinged to another rear end portion of the seat cushion frame and having a lower end portion hinged to a rear end portion of the second side frame, a sector gear formed at a front portion of the upper end portion of the first height adjustment link, a height adjustment motor mounted to the one rear end portion of the seat cushion frame, and a pinion mounted to an output shaft of the height adjustment motor and engaged with the sector gear.

In yet another further preferred embodiment, the upper end portion of the first height adjustment link may have formed therethrough a curved slot configured to limit a vertical movement range of the seat cushion frame, and the one rear end portion of the seat cushion frame may have a guide pin protruding therefrom and movably inserted into the curved slot.

A vehicle seat may include the device for adjusting the position of the vehicle seat.

A vehicle may include the device for adjusting the position of the vehicle seat.

In additional aspects, vehicles are provided that comprises a seat and seat assembly as disclosed herein.

In certain aspects, a present vehicle may be an autonomous vehicle.

In a fully autonomous vehicle or system, the vehicle may perform all driving tasks under all conditions and little or no driving assistance is required a human driver. In semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

In certain embodiments, the present systems and vehicles may be fully autonomous. In other certain embodiments, the present systems and vehicles may be semi-autonomous.

Other aspects and preferred embodiments of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 (RELATED ART) is a schematic view illustrating an example in which a vehicle seat is adjusted to a comfortable relaxation posture;

FIGS. 2 and 3 are perspective views illustrating a device for adjusting the position of a vehicle seat according to the present disclosure;

FIG. 4 is a side view illustrating a state in which a seat cushion frame is lowered by a device for adjusting the position of a vehicle seat according to the present disclosure;

FIG. 5 is a side view illustrating a state in which a seat cushion frame is tilted by a device for adjusting the position of a vehicle seat according to the present disclosure; and

FIG. 6 is a side view illustrating a state in which a seat cushion frame is raised by a device for adjusting the position of a vehicle seat according to the present disclosure.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In this specification, the terms “first,” “second,” etc. may be used to describe various components, but the components are not limited to the terms. These terms are only used to distinguish one component from another. For example, a first component could be termed a second component, and similarly, a second component could be termed a first component, without departing from the scope of exemplary embodiments of the present disclosure.

It should be understood that when a component is referred to as being “connected to” another component, the component may be directly connected to the other component or intervening components may also be present. In contrast, when a component is referred to as being “directly connected to” another component, there are no intervening components present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes plural forms unless specified otherwise.

Hereinafter, preferred embodiments of the present disclosure will be described with reference to the accompanying drawings.

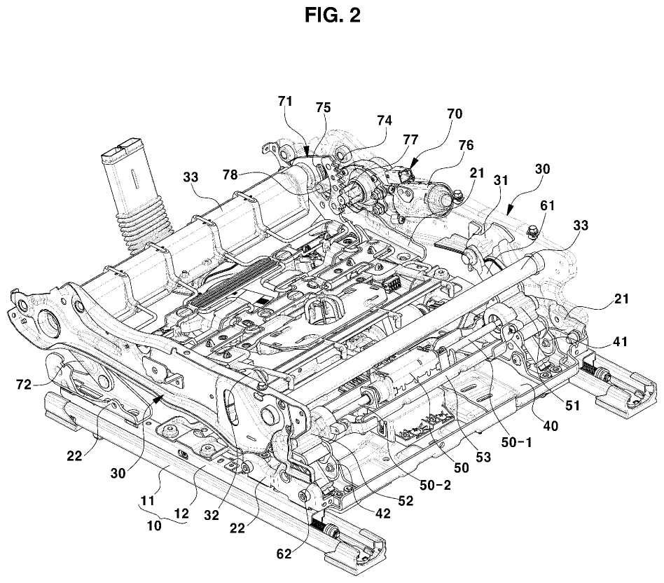

FIGS. 2 and 3 are perspective views illustrating a device for adjusting the position of a vehicle seat (hereinafter, a seat position adjustment device) according to the present disclosure, wherein reference numeral 10 denotes a seat rail.

The seat rail 10 is provided as an identical pair and mounted on a floor panel, which is the interior floor of the vehicle, by being spaced apart from each other in a left-right direction.

Each of the seat rails 10 generally includes a fixed rail 11 fixed and mounted to the floor panel and a movement rail 12 forwardly and rearwardly movably coupled to the fixed rail 11. The front and rear position of the seat may be adjusted by moving the movement rail 12 forward and rearward along the fixed rail 11.

One of the seat rails 10 mounts thereto a first side frame 21 and the other one of the seat rails 10 mounts thereto a second side frame 22.

Technically, each of the first side frame 21 and the second side frame 22 is integrally assembled on a corresponding movement rail 12 of the seat rail 10.

To a rear end portion of the first side frame 21 and to a rear end portion of the second side frame 22, opposite rear end portions of a seat cushion frame 30 are hinged, respectively.

To be more specific, the opposite rear end portions of the seat cushion frame 30 are hinged to the rear end portions of the first and second side frames 21 and 22 via first and second height adjustment links 71 and 72 of a height adjustment device 70, respectively.

Preferably, opposite front end portions of the seat cushion frame 30 are connected to each other via a connection pipe 33, and the opposite rear end portions of the seat cushion frame 30 are connected to each other via a connection pipe 33 to reinforce the rigidity of the seat cushion frame 30.

Between the first side frame 21 and the second side frame 22, a support plate 40 is disposed in a transverse direction to connect the first side frame 21 and the second side frame 22 to each other.

The support plate 40 integrally connects the first side frame 21 to the second side frame 22 so that, when the movement rails 12 move forward and rearward, the first side frame 21 and the second side frame 22 may move forward and rearward together therewith, and the support plate 40 serves to support an actuator configured to tilt the seat cushion frame 30.

Particularly, as the actuator configured to tilt the seat cushion frame 30, a first gearbox 51 and a second gearbox 52 are disposed at opposite side portions of the support plate 40, respectively, and a double-axis motor 50 for tilt control configured to input rotational power to the first gearbox 51 and to the second gearbox 52 is disposed between the first gearbox 51 and the second gearbox 52.

To this end, the first gearbox 51 is hinged to one end portion of the support plate 40 and the second gearbox 52 is hinged to another end portion of the support plate 40.

Preferably, the first gearbox 51 is hinged to a first support bracket 41 mounted at one side position on the upper surface of the support plate 40, and the second gearbox 52 is hinged to a second support bracket 42 mounted at another side position on the upper surface of the support plate 40.

Moreover, the first gearbox 51 and the second gearbox 52 are integrally connected to each other via a base frame 53 disposed in a transverse direction, and the double-axis motor 50 for tilt control configured to transmit rotational power to the first gearbox 51 and to the second gearbox 52 is mounted above the base frame 53.

Here, a first rotation transmission shaft 50-1 configured to connect one output portion of the motor 50 to an input portion of the first gearbox 51, and a second rotation transmission shaft 50-2 configured to connect another output portion of the motor 50 to an input portion of the second gearbox 52 may be adopted as a flexible cable instead of a rigid metal shaft.

Therefore, even if vibration of the vehicle body or vibratory loads act on the seat, the rotational power of the motor 50 may be stably transmitted to each of the gearboxes via the flexible cables.

The first gearbox 51 has a first lead screw 61, configured to tilt one side portion of the seat cushion frame 30 and forwardly and rearwardly movably fastened to the first gearbox 51, and the second gearbox 52 has a second lead screw 62, configured to tilt another side portion of the seat cushion frame 30 and forwardly and rearwardly movably fastened to the second gearbox 52.

For reference, a general gear train, although not shown, is installed inside each of the first gearbox 51 and the second gearbox 52 to move the first lead screw 61 and the second lead screw 62 forward and rearward.

More specifically, an upper end portion of the first lead screw 61 is hinged to one front end portion of the seat cushion frame 30 and a lower end portion of the first lead screw 61 is forwardly and rearwardly movably inserted and fastened to the first gear box 51, and an upper end portion of the second lead screw 62 is hinged to another front end portion of the seat cushion frame 30 and a lower end portion of the second lead screw 62 is forwardly and rearwardly movably inserted and fastened to the second gearbox 52.

Here, the one front end portion of the seat cushion frame 30 has mounted thereto a first hinge bracket 31 to which the upper end portion of the first lead screw 61 is hinged, and the other front end portion of the seat cushion frame 30 has mounted thereto a second hinge bracket 32 to which the upper end portion of the second lead screw 62 is hinged.

Meanwhile, between the opposite rear end portions of the seat cushion frame 30 and the rear end portions of the first and second side frames 21 and 22, a height adjustment device 70 configured to raise or lower the seat cushion frame 30 so as to adjust the height of the seat is further mounted.

By an operation of the height adjustment device 70, the seat cushion frame 30 may be raised forwardly in a curved trajectory or may be lowered rearwardly in a curved trajectory.

To this end, the height adjustment device 70 includes the first height adjustment link 71 having an upper end portion hinged to one rear end portion of the seat cushion frame 30 and having a lower end portion hinged to the rear end portion of the first side frame 21, and a second height adjustment link 72 having an upper end portion hinged to another rear end portion of the seat cushion frame 30 and having a lower end portion hinged to the rear end portion of the second side frame 22.

Moreover, a sector gear 74 is formed at a front portion of the upper end portion of the first height adjustment link 71, and a height adjustment motor 76 is mounted to an external side surface of the one rear end portion of the seat cushion frame 30.

Furthermore, because an output shaft of the height adjustment motor 76 is formed through the one rear end portion of the seat cushion frame 30, a pinion 77 engaged with the sector gear 74 is mounted to the output shaft of the height adjustment motor 76.

Additionally, an upper end portion of the first height adjustment link 71, i.e., a portion rearwardly of the sector gear 74, has formed therethrough a curved slot 75 configured to limit the vertical movement range of the seat cushion frame 30, and an internal side surface of the one rear end portion of the seat cushion frame 30 has a guide pin 78 protruding therefrom and movably inserted into the curved slot 75.

Here, the operation flow of the seat position adjustment device of the present disclosure having the above-described structure is as follows.

### Tilting Operation of Seat Cushion Frame

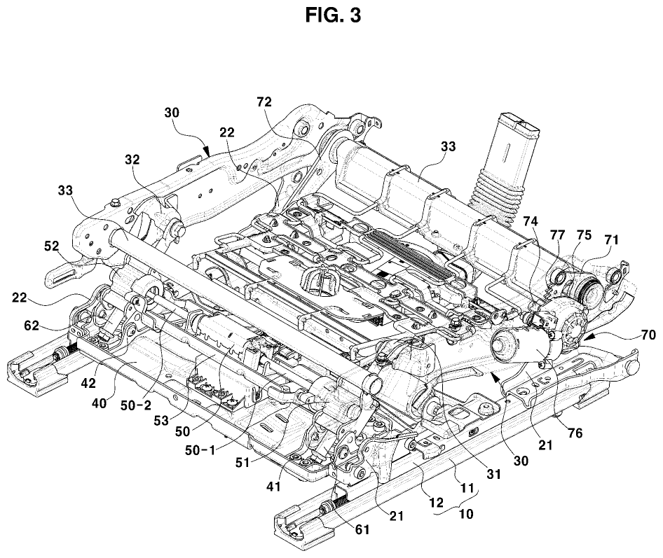

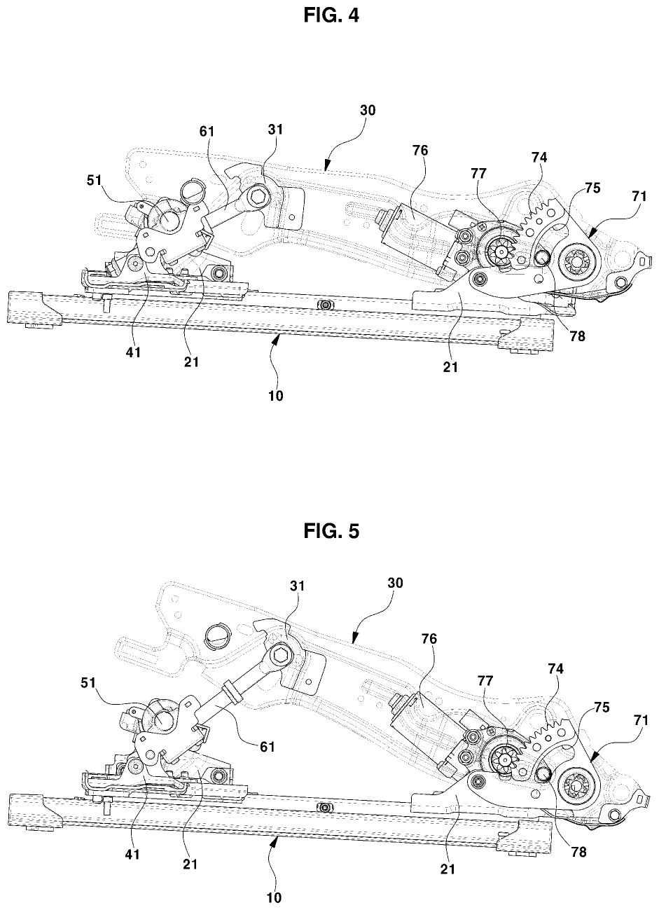

FIG. 4 is a side view illustrating a state in which the seat cushion frame is lowered by the seat position adjustment device of the present disclosure, the state in which the seat position is adjusted to a default seating position, and FIG. 5 is a side view illustrating a state in which the seat cushion frame is tilted by the seat position adjustment device of the present disclosure.

As illustrated in FIG. 4, when the seat position is adjusted to the default seating position, the first gearbox 51 and the second gearbox 52 are arranged to be tilted rearward, and the first lead screw 61 and the second lead screw 62 are arranged to be tilted rearward and fully reversed downward.

Furthermore, the pinion 77 connected to the output shaft of the height adjustment motor 76 is kept being engaged with the lowermost portion of the sector gear 74 formed in the first height adjustment link 71.

In the state of the seat position adjusted to the default seating position as described above, when the double-axis motor 50 for tilt control is rotated in one direction, the rotational power is input to the first gearbox 51 via the first rotation transmission shaft 50-1, which is a flexible cable, and at the same time, the rotational power is input to the second gearbox 52 via the second rotation transmission shaft 50-2, which is a flexible cable.

Subsequently, the first lead screw 61 moves upward by the operation of the gear train embedded in the first gearbox 51 as deceleration is achieved by the gear train embedded in the first gearbox 51, and at the same time, the second lead screw 62 moves upward by the operation of the gear train embedded in the second gearbox 52 as deceleration is achieved by the gear train embedded in the second gearbox 52.

Thereafter, as illustrated in FIG. 5, the first lead screw 61 pushes the one front end portion of the seat cushion frame 30 upward and the second lead screw 62 pushes the other front end portion of the seat cushion frame 30 upward, raising the front end portions of the seat cushion frame 30.

Simultaneously, as illustrated in FIG. 5, the first height adjustment link 71 connected to the one rear end portion of the seat cushion frame 30 rotates downward (i.e., rotates in clockwise direction with respect to the orientation in FIG. 5) about its hinged point connected to the first side frame 21, and at the same time, the second height adjustment link 72 connected to the other rear end portion of the seat cushion frame 30 rotates downward about its hinged point connected to the second side frame 22, lowering the rear end portions of the seat cushion frame 30.

As described above, the front end portions of the seat cushion frame 30 are raised and the rear end portions of the seat cushion frame 30 are lowered at the same time, so that the tilting operation of the seat cushion frame 30 is performed.

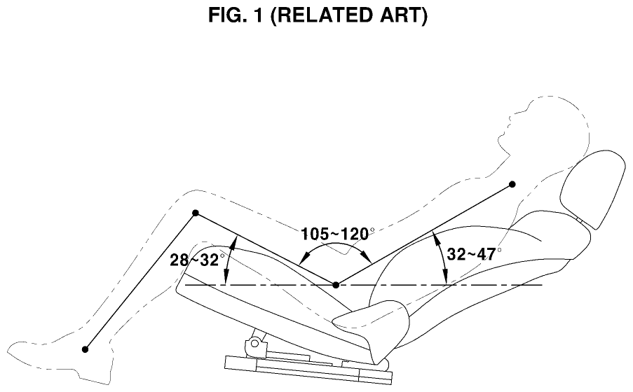

Here, when the tilting operation of the seat cushion frame 30 is performed, a reclining operation of the seatback is performed together therewith as illustrated in FIG. 1, achieving a comfortable relaxation posture.

As such, a lead screw configured to tilt the seat cushion frame 30 includes the first lead screw 61 and the second lead screw 62 connected to the one front end portion and the other front end portion of the seat cushion frame 30, respectively, and the first and second lead screws 61 and 62 are moved forward and rearward using one motor 50 to tilt the seat cushion frame 30, ensuring the seat cushion frame 30 to be stably tilted.

Moreover, the opposite side portions of the seat cushion frame 30 are stably supported and restrained by the first and second lead screws 61 and 62, respectively, to prevent deformation such as the seat cushion frame 30 being twisted to one side due to occupant's loads acting on the seat cushion frame, vehicle vibration, and shock upon a collision, thereby preventing shaking, vibration, and torsional deformation caused by a gap generated when tilting the seat cushion frame.

### Raising and Lowering Operation of Seat Cushion Frame

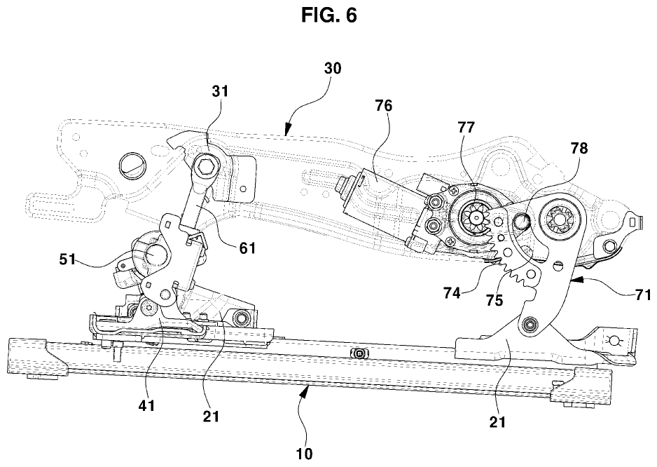

FIG. 4 is a side view illustrating a state in which the seat cushion frame is lowered by the seat position adjustment device of the present disclosure, and FIG. 6 is a side view illustrating a state in which the seat cushion frame is raised by the seat position adjustment device of the present disclosure.

As illustrated in FIG. 4, when the seat position is adjusted to the default seating position, the first gearbox 51 and the second gearbox 52 are arranged to be tilted rearward, and the first lead screw 61 and the second lead screw 62 are arranged to be tilted rearward and fully reversed downward.

Furthermore, the pinion 77 connected to the output shaft of the height adjustment motor 76 is kept being engaged with the lowermost portion of the sector gear 74 formed in the first height adjustment link 71.

Moreover, the guide pin 78 formed on the internal side surface of the one rear end portion of the seat cushion frame 30 is kept being inserted into the lowermost portion of the curved slot 75 formed in the first height adjustment link 71.

In the state of the seat position adjusted to the default seating position as described above, when the height adjustment motor 76 is rotated in one direction, the pinion 77 connected to the output shaft of the height adjustment motor 76 moves upward while meshing with the sector gear 74 formed in the first height adjustment link 71.

Here, when the pinion 77 moves upward while meshing with the sector gear 74 formed in the first height adjustment link 71, the height adjustment motor 76 connected to the pinion 77 and the rear end portion of the seat cushion frame 30 to which the height adjustment motor 76 is mounted may also move upward.

Subsequently, when the rear end portion of the seat cushion frame 30 moves upward, the guide pin 78 formed on the seat cushion frame 30 moves to the uppermost portion of the curved slot 75 formed in the first height adjustment link 71 and pulls the first height adjustment link 71 forward.

Thereafter, when the guide pin 78 formed on the seat cushion frame 30 moves to the uppermost portion of the curved slot 75 and pulls the first height adjustment link 71 forward, the first height adjustment link 71 rotates forward as illustrated in FIG. 6 (i.e., rotates in counterclockwise direction with respect to the orientation in FIG. 6) and stands vertically, thereby raising the one rear end portion of the seat cushion frame 30.

To elaborate, the first height adjustment link 71 rotates forward about its hinged point connected to the first side frame 21 and stands vertically to raise the one rear end portion of the seat cushion frame 30, and the second height adjustment link 72 also rotates forward about its hinged point connected to the second side frame 22 and stands vertically to raise the other rear end portion of the seat cushion frame 30, thereby allowing the rear end portions of the seat cushion frame 30 to be raised forwardly in a curved trajectory.

Here, because the upper end portion of the first lead screw 61 is hinged to the one front end portion of the seat cushion frame 30, the upper end portion of the second lead screw 62 is hinged to the other front end portion of the seat cushion frame 30, the first gearbox 51 is hinged to the first support bracket 41, and the second gearbox 52 is hinged to the second support bracket 42, when the rear end portions of the seat cushion frame 30 are raised forwardly in a curved trajectory, the first lead screw 61 and the second lead screw 62 rotate forward and stand vertically, and at the same time, the first gearbox 51 and the second gearbox 52 also rotate forward, allowing the front end portions of the seat cushion frame 30 to be also raised forwardly in a curved trajectory.

As such, when the rear end portions of the seat cushion frame 30 are raised forwardly in a curved trajectory, the first lead screw 61 and the second lead screw 62 rotate forward and stably support the front end portions of the seat cushion frame 30, and at the same time, the first gearbox 51 and the second gearbox 52 rotate forward and stably support the first lead screw 61 and the second lead screw 62, so that the height of the seat cushion frame 30 may be adjusted stably without being affected by occupant's loads acting on the seat cushion frame or vehicle vibration.

As is apparent from the above description, the present disclosure provides the following effects.

First, lead screws configured to actually tilt a seat cushion frame are connected to opposite side portions of the seat cushion frame, respectively, so that the opposite side portions of the seat cushion frame are stably supported and restrained by the lead screws, thereby preventing shaking, vibration, and torsional deformation caused by a gap generated when tilting the seat cushion frame.

Second, a height adjustment device is mounted at the rear portion of the seat cushion frame, allowing the raising and lowering operation of the seat cushion to be performed to adjust the height of the seat cushion in addition to the tilting operation of the seat cushion.

Although the present disclosure has been described in detail with reference to one embodiment, the scope of the present disclosure is not limited to the above-described embodiment, and various modifications and improvements by those skilled in the art based on the basic concept of the present disclosure as defined in the claims below will also be included in the scope of the present disclosure.

What is claimed is:

1. A device for adjusting a position of a vehicle seat, the device comprising:
a first side frame and a second side frame mounted to a pair of seat rails, respectively;
a seat cushion frame operably connected to the first and second side frames;
a support plate configured to connect the first side frame and the second side frame to each other;
a first gearbox hinged to one end portion of the support plate;
a second gearbox hinged to another end portion of the support plate;
a first adjustment device having an upper end portion hinged to one front end portion of the seat cushion frame and having a lower end portion forwardly and rearwardly movably inserted and fastened to the first gearbox;
a second adjustment device having an upper end portion hinged to another front end portion of the seat cushion frame and having a lower end portion forwardly and rearwardly movably inserted and fastened to the second gearbox;
a base frame configured to connect the first gearbox and the second gearbox to each other; and
a double-axis motor for tilt control mounted to the base frame and connected to the first gearbox and to the second gearbox so as to transmit rotational power to the first and second gearboxes.

2. The device of claim 1, wherein the seat cushion frame has opposite rear end portions hinged to rear end portions of the first and second side frames, respectively.

3. The device of claim 2, wherein, at one side position of an upper surface of the support plate, a first support bracket to which the first gearbox is hinged is mounted.

4. The device of claim 2, wherein, at another side position of an upper surface of the support plate, a second support bracket to which the second gearbox is hinged is mounted.

5. The device of claim 1, wherein the first adjustment device is a first lead screw, and the second adjustment device is a second lead screw.

6. The device of claim 5, wherein the one front end portion of the seat cushion frame has mounted to the one front end portion a first hinge bracket to which the upper end portion of the first lead screw is hinged.

7. The device of claim 5, wherein the other front end portion of the seat cushion frame has mounted to the other front end portion a second hinge bracket to which the upper end portion of the second lead screw is hinged.

8. The device of claim 1, wherein one output portion of the motor is connected to an input portion of the first gearbox via a first rotation transmission shaft and another output portion of the motor is connected to an input portion of the second gearbox via a second rotation transmission shaft, and wherein the first and second rotation transmission shafts are flexible cables.

9. The device of claim 1, wherein opposite front end portions of the seat cushion frame are connected to each other via a connection pipe and the opposite rear end portions of the seat cushion frame are connected to each other via a connection pipe.

10. The device of claim 1, further comprising a height adjustment device mounted to the opposite rear end portions of the seat cushion frame and to the rear end portions of the first and second side frames, and configured to raise or lower the seat cushion frame.

11. The device of claim 10, wherein the height adjustment device comprises:
a first height adjustment link having an upper end portion hinged to one rear end portion of the seat cushion frame and having a lower end portion hinged to a rear end portion of the first side frame;
a second height adjustment link having an upper end portion hinged to another rear end portion of the seat cushion frame and having a lower end portion hinged to a rear end portion of the second side frame;
a sector gear formed at a front portion of the upper end portion of the first height adjustment link;
a height adjustment motor mounted to the one rear end portion of the seat cushion frame; and
a pinion mounted to an output shaft of the height adjustment motor and engaged with the sector gear.

12. The device of claim 11, wherein the upper end portion of the first height adjustment link has formed therethrough a curved slot configured to limit a vertical movement range of the seat cushion frame, and the one rear end portion of the seat cushion frame has a guide pin protruding therefrom and movably inserted into the curved slot.

13. A vehicle seat comprising the device of claim 1.

14. A vehicle comprising the device of claim 1.
